(19) United States
(12) Patent Application Publication
(10) Pub. No.: US 2017/0038009 A1
(43) Pub. Date: Feb. 9, 2017

(54) AC LED LAMP STRUCTURE

(71) Applicant: PARAGON SEMICONDUCTOR LIGHTING TECHNOLOGY CO., LTD, NEW TAIPEI CITY (TW)

(72) Inventors: CHIA-TIN CHUNG, MIAOLI COUNTY (TW); SHEN-TA YANG, TAIPEI CITY (TW); SHIOU LIANG YEH, TAOYUAN COUNTY (TW)

(21) Appl. No.: 14/877,319

(22) Filed: Oct. 7, 2015

(30) Foreign Application Priority Data
Aug. 5, 2015 (TW) 104212606

(51) Int. Cl. F21K 99/00

(52) U.S. Cl. CPC F21K 9/135; F21K 9/50

(57) ABSTRACT

An AC LED lamp structure includes a light-emitting module and a protection module. The light-emitting module includes a circuit substrate positioned on a carrier body and a light-emitting unit disposed on the circuit substrate. The protection module includes a transparent element disposed under the light-emitting unit and separated from the light-emitting unit and a plurality of connection components connected between the transparent element and the carrier body for positioning the transparent element under the circuit substrate by a predetermined distance. Therefore, the flammability class of the AC LED lamp structure is increased by using the transparent element. The predetermined distance from the transparent element to the circuit substrate is smaller than a finger of a user in order to prevent the finger of the user from touching the circuit substrate through a gap between the transparent element and the circuit substrate, and avoid electric shock.

### BACKGROUND OF THE INVENTION

1. Field of the Invention

The instant disclosure relates to a lamp structure, and more particularly to an AC (alternating current) LED lamp structure.

2. Description of Related Art

The invention of the lamp greatly changed the style of building construction and the living style of human beings, allowing people to work during the night. Traditional lighting devices such as lamps that adopt incandescent bulbs, fluorescent bulbs, or power-saving bulbs have been generally well-developed and used intensively indoor illumination. However, compared to the newly developed light-emitting-diode (LED) lamps, these traditional lamps have the disadvantages of quick attenuation, high power consumption, high heat generation, short working life, high fragility, and being not recyclable. Thus, various LED package structures are created to replace the traditional lighting devices.

### SUMMARY OF THE INVENTION

One aspect of the instant disclosure relates to an AC LED lamp structure.

One of the embodiments of the instant disclosure provides an AC LED lamp structure, comprising a light-emitting module and a protection module. The light-emitting module includes a circuit substrate positioned on a carrier body and a light-emitting unit disposed on the circuit substrate and electrically connected to the circuit substrate. The protection module includes a transparent element disposed under the light-emitting unit and separated from the light-emitting unit and a plurality of connection components connected between the transparent element and the carrier body for positioning the transparent element under the circuit substrate by a predetermined distance.

More particularly, each connection component includes a retaining element and a securing element connected between the retaining element and the carrier body, the retaining element has a positioning portion and a holding portion connected to the positioning portion, the positioning portion has a positioning hole, and the holding portion has a retaining space and a retaining rib disposed in the retaining space, wherein the securing element passes through the positioning hole to position the retaining element on the carrier body, and an outer perimeter portion of the transparent element is retained inside the retaining space and downwardly abutted against the retaining rib.

Another one of the embodiments of the instant disclosure provides an AC LED lamp structure, comprising a light-emitting module and a protection module. The light-emitting module includes a circuit substrate positioned on a carrier body and a light-emitting unit disposed on the circuit substrate and electrically connected to the circuit substrate. The protection module includes a transparent element disposed under the light-emitting unit and separated from the light-emitting unit and a plurality of connection components connected between the transparent element and the circuit substrate for positioning the transparent element under the circuit substrate by a predetermined distance.

Yet another one of the embodiments of the instant disclosure provides an AC LED lamp structure, comprising a light-emitting module and a protection module. The light-emitting module includes a circuit substrate positioned on a carrier body and a light-emitting unit disposed on the circuit substrate and electrically connected to the circuit substrate. The protection module includes a protection casing for carrying the light-emitting module, a transparent element disposed inside the protection casing and separated from the light-emitting unit, and a plurality of connection components connected between the protection casing and the carrier body for positioning the transparent element under the circuit substrate by a predetermined distance.

More particularly, the light-emitting module includes a frame unit and a package unit. The frame unit includes a surrounding light-reflecting resin body surroundingly coated on the top surface of the circuit substrate. The surrounding light-reflecting resin body surrounds the light-emitting unit to form a resin position limiting space on the circuit substrate, and the surrounding light-reflecting resin body has a convex junction portion formed on a top surface thereof. The package unit includes a light-transmitting resin body disposed on the top surface of the circuit substrate for enclosing the light-emitting unit. The light-transmitting resin body is disposed inside the resin position limiting space and surrounded by the surrounding light-reflecting resin body.

More particularly, the light-emitting unit includes a first light-emitting group and a second light-emitting group, and the light-emitting module includes a frame unit and a package unit. The frame unit includes a first surrounding light-reflecting resin body surroundingly coated on the top surface of the circuit substrate and a second surrounding light-reflecting resin body surroundingly coated on the top surface of the circuit substrate for surrounding the first surrounding light-reflecting resin body. The first surrounding light-reflecting resin body surrounds the first light-emitting group to form a first resin position limiting space on the circuit substrate, and the second surrounding light-reflecting resin body surrounds the second light-emitting group and the first surrounding light-reflecting resin body to form a second resin position limiting space on the circuit substrate and between the first surrounding light-reflecting resin body and the second surrounding light-reflecting resin body, the first surrounding light-reflecting resin body has a first convex junction portion formed on a top surface thereof, and the second surrounding light-reflecting resin body has a second convex junction portion formed on a top surface thereof. The package unit includes a first light-transmitting resin body and a second light-transmitting resin body disposed on the top surface of the circuit substrate to respectively enclose the first light-emitting group and the second light-emitting group. The first light-transmitting resin body and the second light-transmitting resin body are respectively disposed inside the first resin position limiting space and the second resin position limiting space and respectively surrounded by the first surrounding light-reflecting resin body and the second surrounding light-reflecting resin body.

More particularly, the first light-emitting group includes a plurality of first LED chips disposed on the circuit substrate and electrically connected to the circuit substrate, the second light-emitting group includes a plurality of second LED chips disposed on the circuit substrate and electrically connected to the circuit substrate, wherein the first surrounding light-reflecting resin body and the second surrounding light-reflecting resin body are arranged in a pattern of concentric circles, the second light-emitting group is disposed between the first surrounding light-reflecting resin body and the second surrounding light-reflecting resin body, and the second light-emitting group surrounds the first surrounding light-reflecting resin body.

Therefore, the flammability class of the AC LED lamp structure is increased by using the transparent element. In addition, the predetermined distance from the transparent element to the circuit substrate is smaller than a finger of a user in order to prevent the finger of the user from touching the circuit substrate through a gap between the transparent element and the circuit substrate, so that the design of the narrow predetermined distance between the transparent element and the circuit substrate can avoid electric shock.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 shows a perspective, schematic view of the connection component of the AC LED lamp structure according to the first embodiment of the instant disclosure;

FIG. 2 shows another perspective, schematic view of the connection component of the AC LED lamp structure according to the first embodiment of the instant disclosure;

FIG. 3 shows a lateral, cross-sectional, schematic view of the AC LED lamp structure according to the first embodiment of the instant disclosure;

FIG. 4 shows a lateral, cross-sectional, schematic view of the AC LED lamp structure according to the second embodiment of the instant disclosure;

FIG. 5 shows a lateral, cross-sectional, schematic view of the AC LED lamp structure according to the third embodiment of the instant disclosure;

FIG. 6 shows a perspective, schematic view of the AC LED lamp structure using a light-emitting module according the instant disclosure;

FIG. 7 shows a top, schematic view of the AC LED lamp structure using one type of the light-emitting modules according the instant disclosure;

FIG. 8 shows a lateral, cross-sectional, schematic view of the AC LED lamp structure using one type of the light-emitting modules according the instant disclosure;

FIG. 9 shows a partial, top, schematic view of the circuit substrate of the AC LED lamp structure according the instant disclosure;

FIG. 10 shows a perspective, exploded, schematic view of the AC LED lamp structure according to the fourth embodiment of the instant disclosure;

FIG. 11 shows another perspective, exploded, schematic view of the AC LED lamp structure according to the fourth embodiment of the instant disclosure;

FIG. 12 shows a perspective, assembled, schematic view of the AC LED lamp structure according to the fourth embodiment of the instant disclosure;

FIG. 13 shows a lateral, cross-sectional, schematic view of the AC LED lamp structure according to the fourth embodiment of the instant disclosure;

FIG. 14 shows a perspective, exploded, schematic view of the AC LED lamp structure according to the fifth embodiment of the instant disclosure;

FIG. 15 shows another perspective, exploded, schematic view of the AC LED lamp structure according to the fifth embodiment of the instant disclosure;

FIG. 16 shows a perspective, assembled, schematic view of the AC LED lamp structure according to the fifth embodiment of the instant disclosure; and

FIG. 17 shows a lateral, cross-sectional, schematic view of the AC LED lamp structure according to the fifth embodiment of the instant disclosure.

### DETAILED DESCRIPTION OF THE PREFERRED EMBODIMENTS

The embodiments of the AC LED lamp structure of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

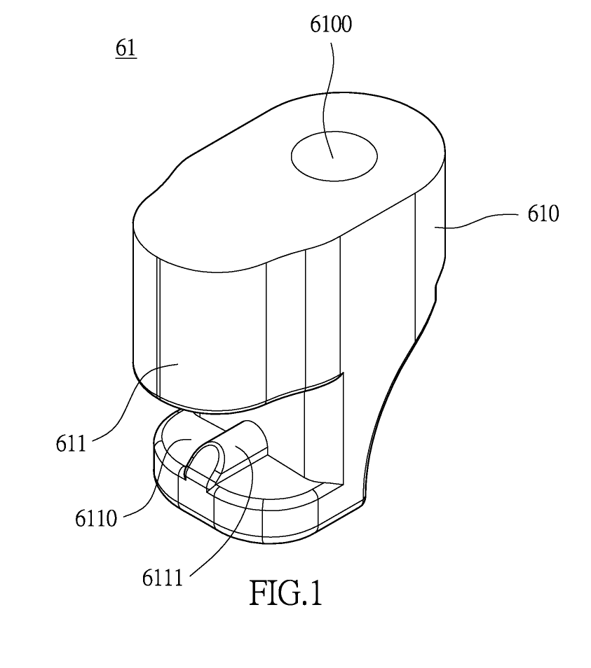

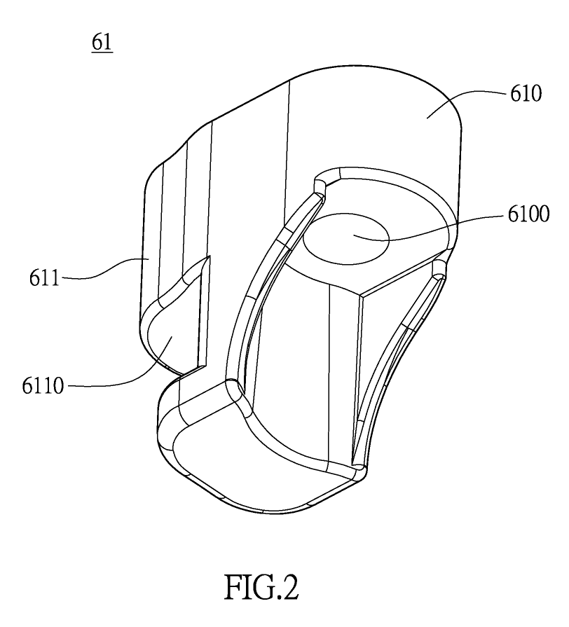

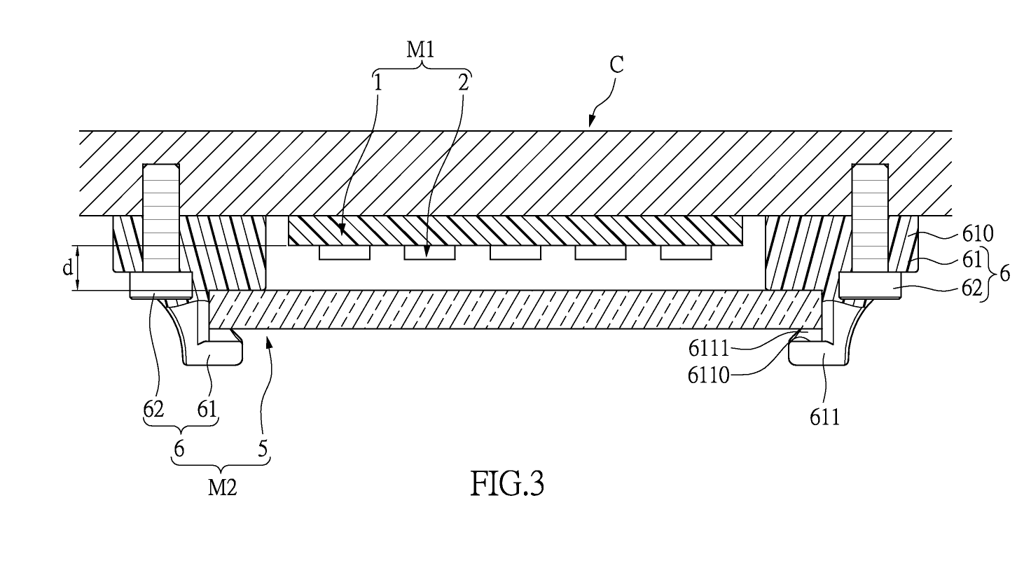

Referring to FIG. 1 to FIG. 3, the first embodiment of the instant disclosure provides an AC LED lamp structure, comprising: a light-emitting module M1 and a protection module M2.

First, the light-emitting module M1 includes a circuit substrate 1 positioned on a carrier body C (such as a ceiling, a plastic board, or a metal board) and a light-emitting unit 2 (such as including many SMD type AC LEDs) disposed on the circuit substrate 1 and electrically connected to the circuit substrate 1. In addition, the protection module M2 includes a transparent element 5 (such as a transparent glass or a UL94 5VA rated transparent plastic) disposed under the light-emitting unit 2 and separated from the light-emitting unit 2 and a plurality of connection components 6 (such as connection assemblies) connected between the transparent element 5 and the carrier body C for positioning the transparent element 5 under the circuit substrate 1 by a predetermined distance d. Moreover, each connection component 6 (such as each connection assembly) includes a retaining element 61 and a securing element 62 connected between the retaining element 61 and the carrier body C. Furthermore, the retaining element 61 has a positioning portion 610 and a holding portion 611 connected to the positioning portion 610, the positioning portion 610 has a positioning hole 6100, and the holding portion 611 has a retaining space 6110 and a retaining rib 6111 disposed in the retaining space 6110. Therefore, the securing element 62 passes through the positioning hole 6100 to position the retaining element 61 on the carrier body C, and an outer perimeter portion (or a surrounding peripheral portion) of the transparent element 5 is retained or held inside the retaining space 6110 and downwardly abutted against the retaining rib 6111.

Please note, the flammability class of the AC LED lamp structure is increased by using the transparent element 5 such as a transparent glass or a UL94 5VA rated transparent plastic. In addition, the predetermined distance d from the transparent element 5 to the circuit substrate 1 is smaller than a finger of a user in order to prevent the finger of the user from touching the circuit substrate 1 through a gap between the transparent element 5 and the circuit substrate 1, so that the design of the narrow predetermined distance d between the transparent element 5 and the circuit substrate 1 can avoid electric shock.

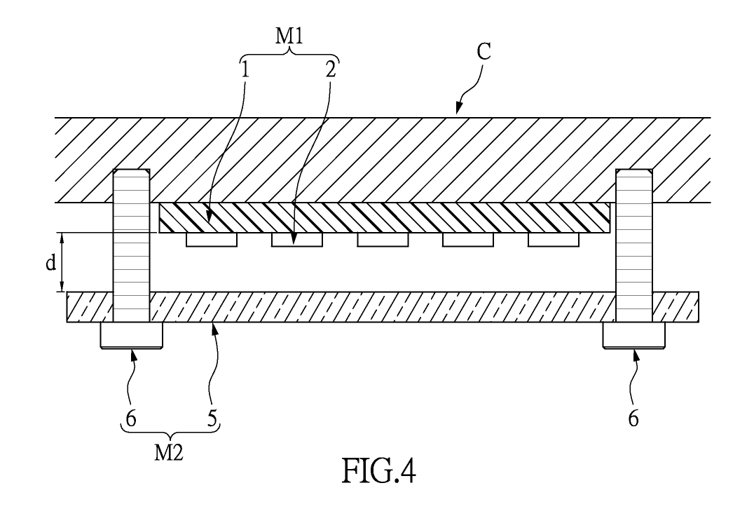

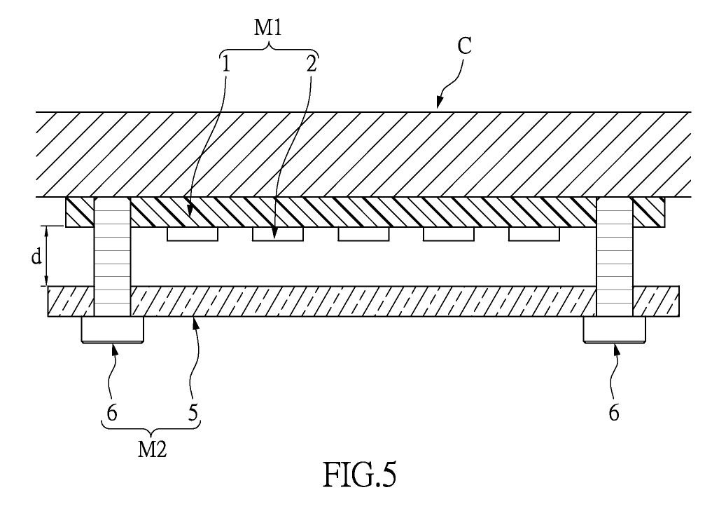

Referring to FIG. 4 and FIG. 5, the second and the third embodiments of the instant disclosure provide an AC LED lamp structure, comprising: a light-emitting module M1 and a protection module M2. The light-emitting module M1 includes a circuit substrate 1 positioned on a carrier body C (such as a ceiling, a plastic board, or a metal board) and a light-emitting unit 2 (such as including many SMD type AC LEDs) disposed on the circuit substrate 1 and electrically connected to the circuit substrate 1. In addition, the protection module M2 includes a transparent element 5 (such as a transparent glass or a UL94 5VA rated transparent plastic) disposed under the light-emitting unit 2 and separated from the light-emitting unit 2 and a plurality of connection components 6 (may be any securing component, such as screws or bolts) for positioning the transparent element 5 under the circuit substrate 1 by a predetermined distance d. Please note, the flammability class of the AC LED lamp structure is increased by using the transparent element 5 such as a transparent glass or a UL94 5VA rated transparent plastic. In addition, the predetermined distance d from the transparent element 5 to the circuit substrate 1 is smaller than a finger of a user in order to prevent the finger of the user from touching the circuit substrate 1 through a gap between the transparent element 5 and the circuit substrate 1, so that the design of the narrow predetermined distance d between the transparent element 5 and the circuit substrate 1 can avoid electric shock.

More particularly, as shown in FIG. 4, in the second embodiment, the connection components 6 are connected between the transparent element 5 and the carrier body C for positioning the transparent element 5 under the circuit substrate 1 by a predetermined distance d. As shown in FIG. 5, in the third embodiment, the connection components 6 are connected between the transparent element 5 and the circuit substrate 1 for positioning the transparent element 5 under the circuit substrate 1 by a predetermined distance d. In other words, the transparent element 5 can be positioned under the circuit substrate 1 by a predetermined distance d by screwing the connection components 6 upon the carrier body C or the circuit substrate 1, according to different requirements.

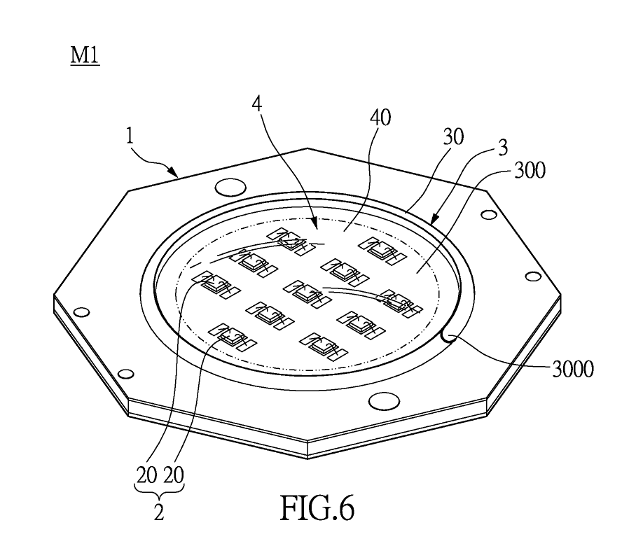

For example, as shown in FIG. 6, the light-emitting unit 2 includes a plurality of LED chips 20 (bare chips). In addition, the light-emitting module M1 further includes a frame unit 3 and a package unit 4. The frame unit 3 includes a surrounding light-reflecting resin body 30 surroundingly coated on the top surface of the circuit substrate 1. The surrounding light-reflecting resin body 30 surrounds the light-emitting unit 2 to form a resin position limiting space 300 on the circuit substrate 1, and the surrounding light-reflecting resin body 30 has a convex junction portion 3000 (or a concave junction portion) formed on a top surface thereof. In other words, when the surrounding light-reflecting resin body 30 is going to finish by surroundingly coating, a convex junction portion 3000 (or a concave junction portion) is formed naturally on the surrounding light-reflecting resin body 30. Moreover, the package unit 4 includes a light-transmitting resin body 40 disposed on the top surface of the circuit substrate 1 for enclosing or encapsulating the light-emitting unit 2, and the light-transmitting resin body 40 is disposed inside the resin position limiting space 300 and surrounded by the surrounding light-reflecting resin body 30.

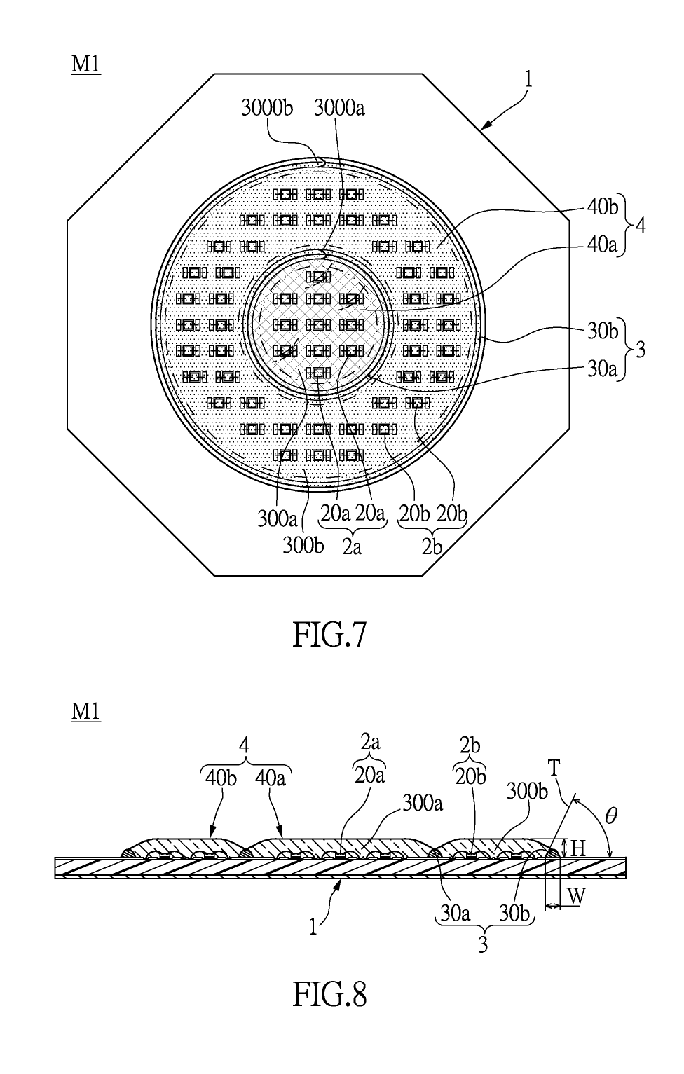

For example, referring to FIG. 7 and FIG. 8, the light-emitting unit 2 includes a first light-emitting group 2a and a second light-emitting group 2b. In addition, the light-emitting module M1 further includes a frame unit 3 and a package unit 4. The frame unit 3 includes a first surrounding light-reflecting resin body 30a surroundingly coated on the top surface of the circuit substrate 1 and a second surrounding light-reflecting resin body 30b surroundingly coated on the top surface of the circuit substrate 1 for surrounding the first surrounding light-reflecting resin body 30a. The first surrounding light-reflecting resin body 30a surrounds the first light-emitting group 2a to form a first resin position limiting space 300a on the circuit substrate 1, and the second surrounding light-reflecting resin body 30b surrounds the second light-emitting group 2b and the first surrounding light-reflecting resin body 30a to form a second resin position limiting space 300b on the circuit substrate 1 and between the first surrounding light-reflecting resin body 30a and the second surrounding light-reflecting resin body 30b. Moreover, the package unit 4 includes a first light-transmitting resin body 40a and a second light-transmitting resin body 40b disposed on the top surface of the circuit substrate 1 to respectively enclose the first light-emitting group 2a and the second light-emitting group 2b, and the first light-transmitting resin body 40a and the second light-transmitting resin body 40b are respectively disposed inside the first resin position limiting space 300a and the second resin position limiting space 300b and respectively surrounded by the first surrounding light-reflecting resin body 30a and the second surrounding light-reflecting resin body 30b.

Following the above description, the first light-emitting group 2a includes a plurality of first LED chips 20a disposed on the circuit substrate 1 and electrically connected to the circuit substrate 1, and the second light-emitting group 2b includes a plurality of second LED chips 20b disposed on the circuit substrate 1 and electrically connected to the circuit substrate 1. In addition, the first surrounding light-reflecting resin body 30a and the second surrounding light-reflecting resin body 30b are arranged in a pattern of concentric circles, the second light-emitting group 2b is disposed between the first surrounding light-reflecting resin body 30a and the second surrounding light-reflecting resin body 30b, and the second light-emitting group 2b surrounds the first surrounding light-reflecting resin body 30a. Furthermore, the first surrounding light-reflecting resin body 30a has a first convex junction portion 3000a (or a first concave junction portion) formed on a top surface thereof, and the second surrounding light-reflecting resin body 30b has a second convex junction portion 3000b (or a second concave junction portion) formed on a top surface thereof.

For example, the method for forming the first surrounding light-reflecting resin body 30a (or the second surrounding light-reflecting resin body 30a) includes: first, surroundingly coating liquid colloid (not shown) on the top surface of the circuit substrate 1. In addition, the liquid colloid can be coated on the circuit substrate 1 to form any shapes according to different requirements (such as a circular shape, a square or a rectangular shape etc.). The thixotropic index of the liquid colloid may be between 4 and 6, the pressure of coating the liquid colloid on the top surface of the circuit substrate 1 may be between 350 kpa and 450 kpa, and the velocity of coating the liquid colloid on the top surface of the circuit substrate 1 may be between 5 mm/s and 15 mm/s. The liquid colloid is surroundingly coated on the top surface of the circuit substrate 1 from an initial point to a terminal point, and the position of the initial point and the position of the terminal point are substantially the same or overlapping, so that the first surrounding light-reflecting resin body 30a (or the second surrounding light-reflecting resin body 30a) has a micro convex portion close to the initial point and the terminal point. Furthermore, the method further includes: hardening or curing the liquid colloid to form a first surrounding light-reflecting resin body 30a. In addition, the liquid colloid is hardened by baking or curing, the baking temperature may be between 120° C. and 140° C., and the baking time may be between 20 minutes and 40 minutes. Therefore, the first surrounding light-reflecting resin body 30a has an arc shape formed on the top surface thereof, the first surrounding light-reflecting resin body 30a has a radius tangent T and the angle θ of the radius tangent T relative to the top surface of the circuit substrate 1 may be between 40° and 50°, the maximum height H of the first surrounding light-reflecting resin body 30a relative to the top surface of the circuit substrate 1 may be between 0.3 mm and 0.7 mm, the width W of the bottom side of the first surrounding light-reflecting resin body 30a may be between 1.5 mm and 3 mm, the thixotropic index of the first surrounding light-reflecting resin body 30a may be between 4 and 6, and the first surrounding light-reflecting resin body 30a is formed by mixing inorganic additive with white thermohardening colloid.

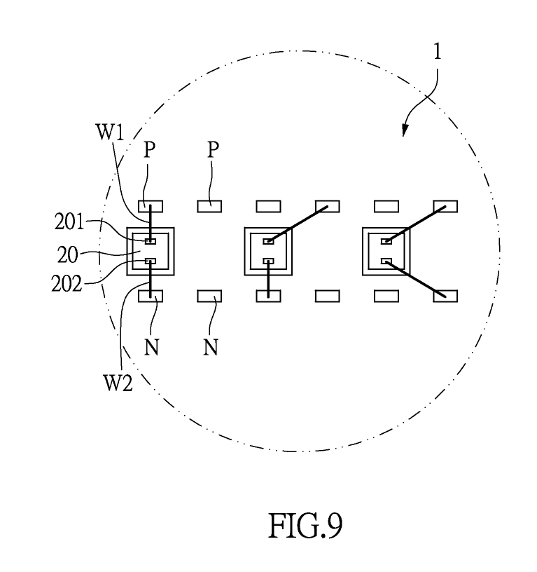

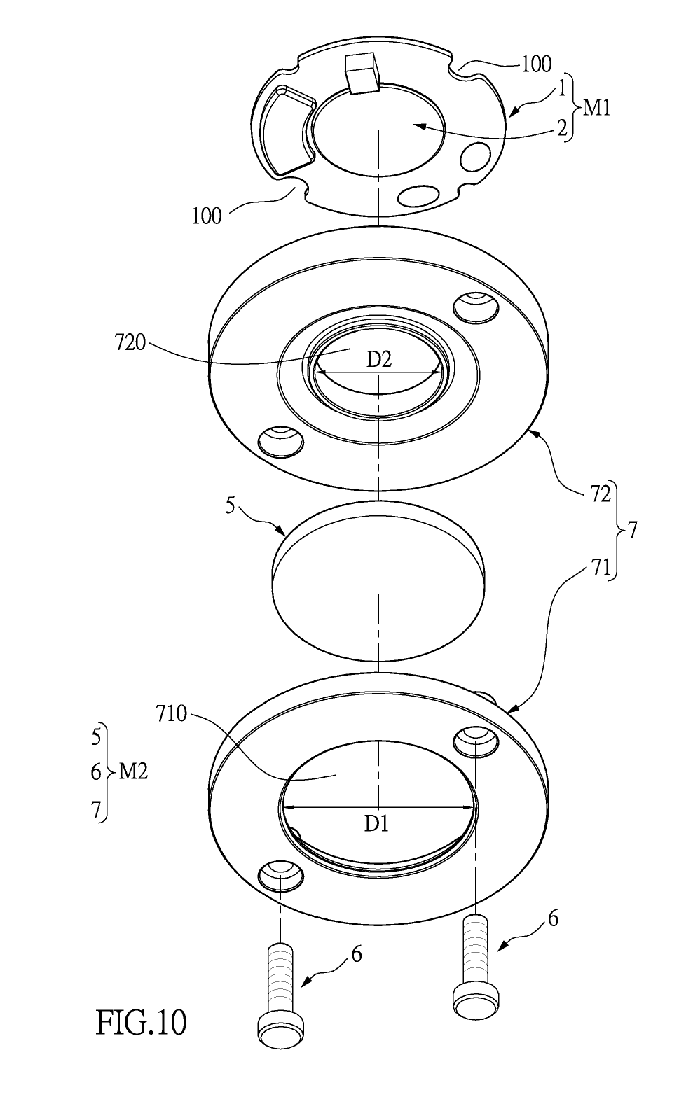

Please note, referring to FIG. 9, the circuit substrate 1 includes a plurality of positive pads P and negative pads N disposed on the top surface of the circuit substrate 1. Each LED chip 20 has a positive electrode 201 and a negative electrode 202. The positive electrode 201 of each LED chip 20 corresponds to at least two of the positive pads P, and the negative electrode 202 of each LED chip 20 corresponds to at least two of the negative pads N. In addition, one of positive conductive wires W1 is electrically connected between the positive electrode 201 of each LED chip 20 and one of the at least two positive pads P, and one of negative conductive wire W2 is electrically connected between the negative electrode 202 of each LED chip 20 and one of the at least two negative pads N. Hence, the positive electrode 201 of each LED chip 20 has at least one standby positive pad P, and the negative electrode 202 of each LED chip 20 has at least one standby negative pad N.

Following the above description, when a first end of the positive conductive wire W1 does not correctly connect with first one of the at least two positive pads P (it means that the positive conductive wire W1 does not electrically connect with the first one of the at least two positive pads P (such as floating solder)), the manufacturer can make the same first end of the positive conductive wire W1 connect to another one of the at least two positive pads P without cleaning solder splash on the surface of the first one of the at least two positive pads P, so that the wire-bonding time (or the wire-bonding efficiency) is decreased and the wire-bonding yield is increased.

Following the above description, when a first end of the negative conductive wire W2 does not correctly connect with first one of the at least two negative pads N (it means that the negative conductive wire W2 does not electrically connect with the first one of the at least two negative pads N (such as floating solder)), the manufacturer can make the same first end of the negative conductive wire W2 connect to another one of the at least two negative pads N without cleaning solder splash on the surface of the first one of the at least two negative pads N, so that the wire-bonding time (or the wire-bonding efficiency) is decreased and the wire-bonding yield is increased.

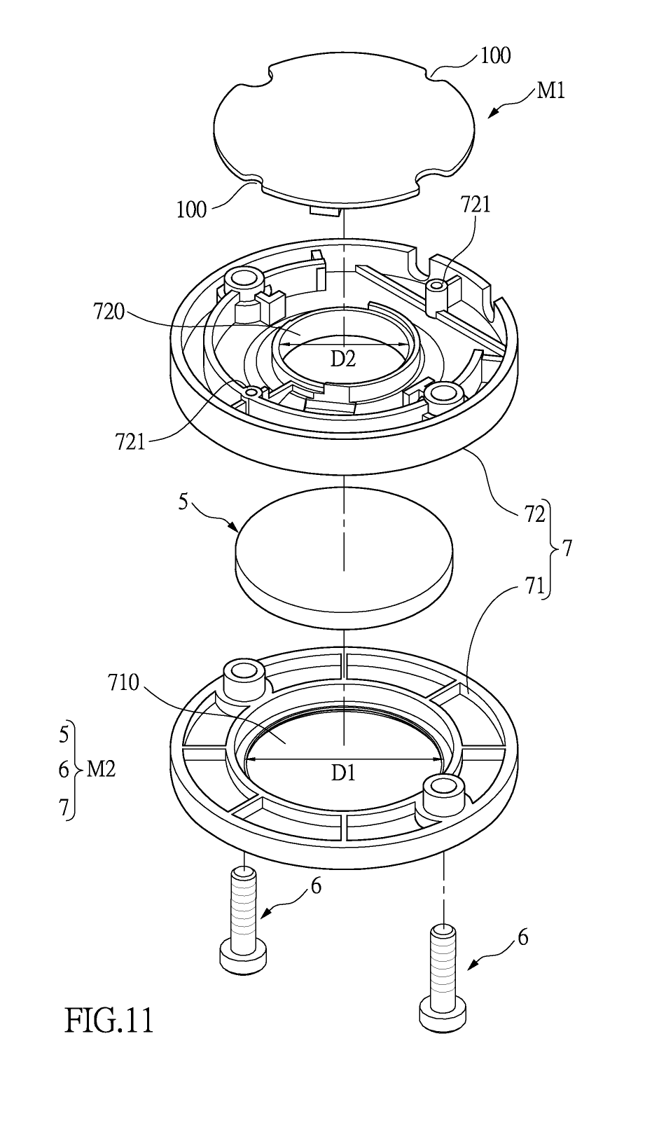

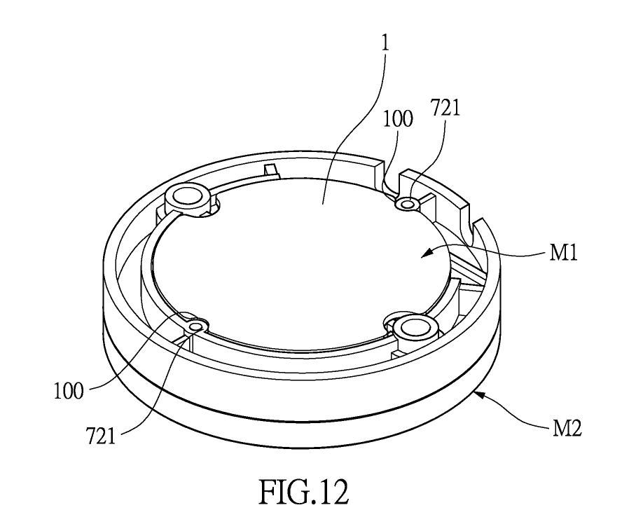

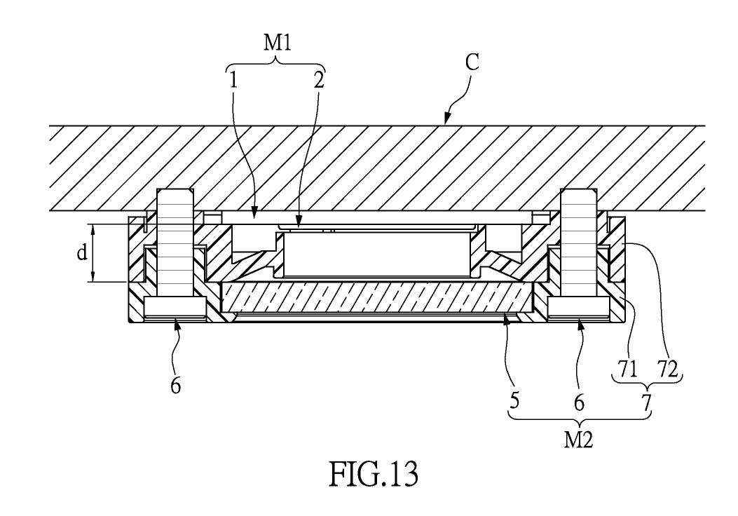

Referring to FIG. 10 to FIG. 13, the fourth embodiment of the instant disclosure provides an AC LED lamp structure, comprising: a light-emitting module M1 and a protection module M2. The light-emitting module M1 includes a circuit substrate 1 positioned on a carrier body C (such as a ceiling, a plastic board, or a metal board) and a light-emitting unit 2 (such as including many SMD type AC LEDs) disposed on the circuit substrate 1 and electrically connected to the circuit substrate 1. In addition, the protection module M2 includes a protection casing 7 for carrying the light-emitting module M1, a transparent element 5 disposed inside the protection casing 7 and separated from the light-emitting unit 2, and a plurality of connection components 6 connected between the protection casing 7 and the carrier body C for positioning the transparent element 5 under the circuit substrate 1 by a predetermined distance d. For example, the protection casing 7 includes a first casing body 71 and a second casing body 72, and the transparent element 5 is enclosed and clamped between the first casing body 71 and the second casing body 72. In addition, the first casing body 71 has a first opening 710, the second casing body 72 has a second opening 720, and a first aperture D1 of the first opening 710 of the first casing body 71 is larger than a second aperture D2 of the second opening 720 of the second casing body 72. Moreover, the first casing body 71 has a plurality of retaining portions 721 contacting the circuit substrate 1 for retaining the circuit substrate 1 of the light-emitting module M1 on a bottom side of the first casing body 71, and the circuit substrate 1 has a plurality of retaining grooves 100 for respectively and correspondingly receiving the retaining portions 721.

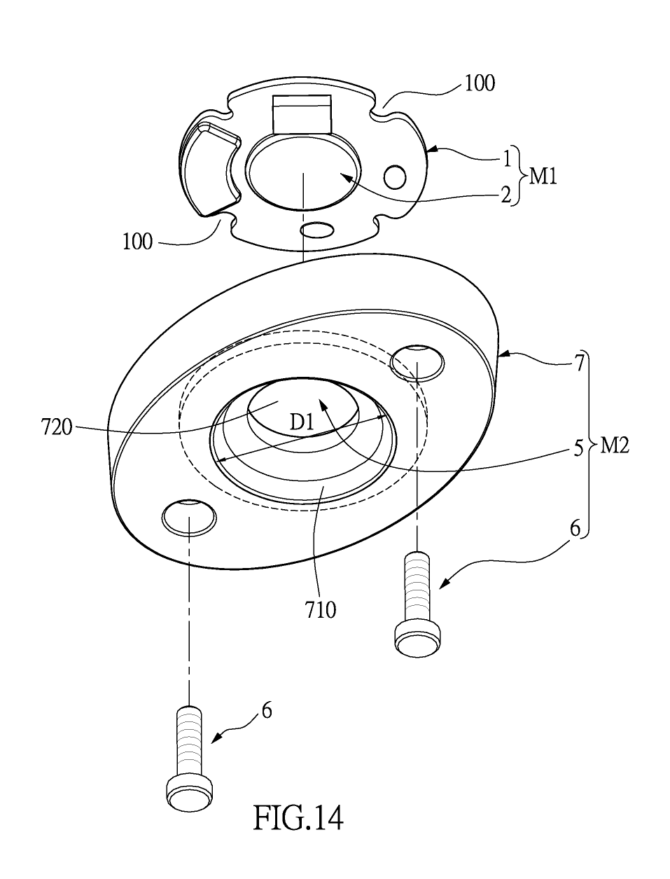

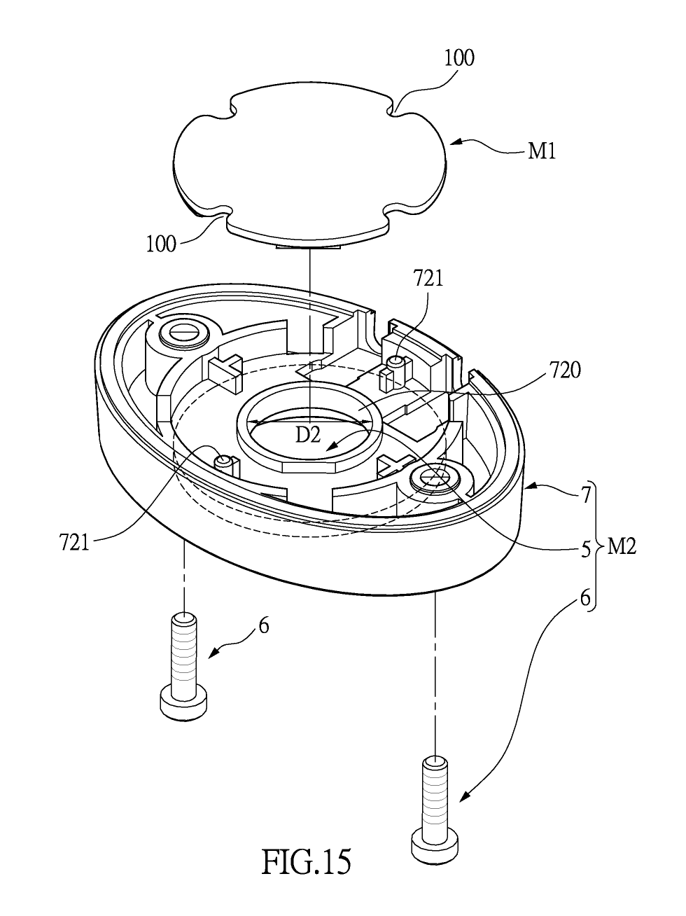

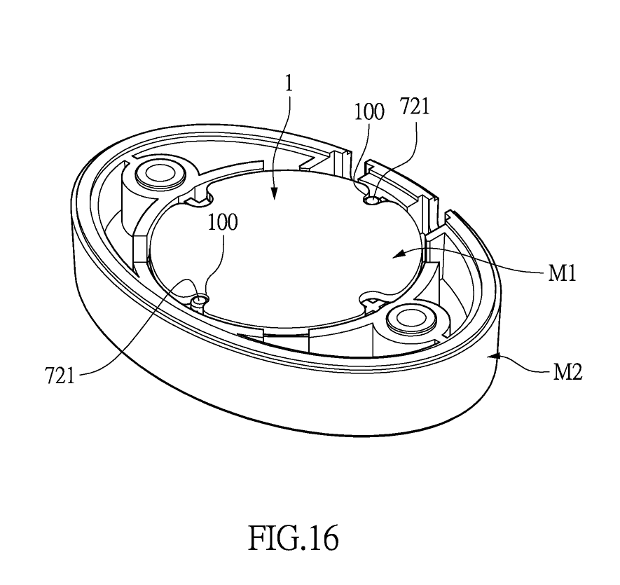

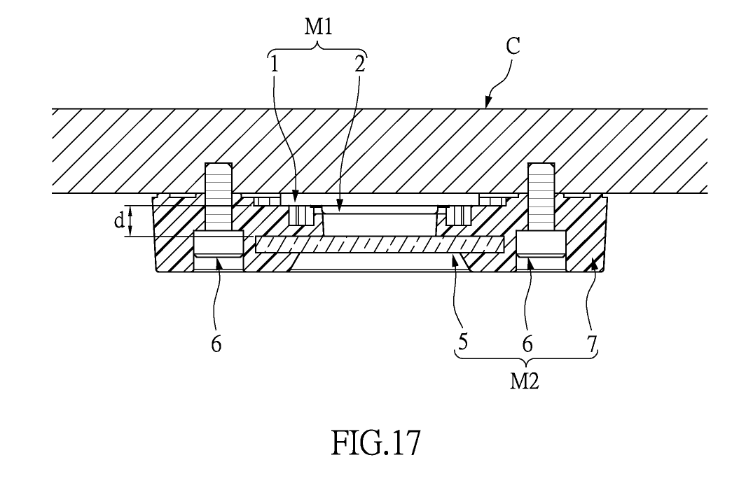

Referring to FIG. 14 to FIG. 17, the fifth embodiment of the instant disclosure provides an AC LED lamp structure, comprising: a light-emitting module M1 and a protection module M2. The light-emitting module M1 includes a circuit substrate 1 positioned on a carrier body C (such as a ceiling, a plastic board, or a metal board) and a light-emitting unit 2 (such as including many SMD type AC LEDs) disposed on the circuit substrate 1 and electrically connected to the circuit substrate 1. In addition, the protection module M2 includes a protection casing 7 for carrying the light-emitting module M1, a transparent element 5 disposed inside the protection casing 7 and separated from the light-emitting unit 2, and a plurality of connection components 6 connected between the protection casing 7 and the carrier body C for positioning the transparent element 5 under the circuit substrate 1 by a predetermined distance d. Furthermore, the protection casing 7 has a first opening 710 and a second opening 720, and the first aperture D1 of the first opening 710 is larger than the second aperture D2 of the second opening 720. More particularly, the protection casing 7 is a single protection shell formed integrally, and the transparent element 5 is enclosed and clamped inside the single protection shell. For example, the first casing body 71 and the second casing body 72 may be connected with each other to form a single protection casing body as the protection casing 7. Furthermore, the first casing body 71 has a plurality of retaining portions 721 contacting the circuit substrate 1 for retaining the circuit substrate 1 of the light-emitting module M1 on a bottom side of the first casing body 71, and the circuit substrate 1 has a plurality of retaining grooves 100 for respectively and correspondingly receiving the retaining portions 721.

In conclusion, the flammability class of the AC LED lamp structure is increased by using the transparent element 5 such as a transparent glass or a UL94 5VA rated transparent plastic. In addition, the predetermined distance d from the transparent element 5 to the circuit substrate 1 is smaller than a finger of a user in order to prevent the finger of the user from touching the circuit substrate 1 through a gap between the transparent element 5 and the circuit substrate 1, so that the design of the narrow predetermined distance d between the transparent element 5 and the circuit substrate 1 can avoid electric shock.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. An AC LED lamp structure, comprising:
a light-emitting module including a circuit substrate positioned on a carrier body and a light-emitting unit disposed on the circuit substrate and electrically connected to the circuit substrate; and
a protection module including a transparent element disposed under the light-emitting unit and separated from the light-emitting unit and a plurality of connection components connected between the transparent element and the carrier body for positioning the transparent element under the circuit substrate by a predetermined distance.

2. The AC LED lamp structure of claim 1, wherein the light-emitting module includes:
a frame unit including a surrounding light-reflecting resin body surroundingly coated on the top surface of the circuit substrate, wherein the surrounding light-reflecting resin body surrounds the light-emitting unit to form a resin position limiting space on the circuit substrate, and the surrounding light-reflecting resin body has a convex junction portion formed on a top surface thereof; and
a package unit including a light-transmitting resin body disposed on the top surface of the circuit substrate for enclosing the light-emitting unit, wherein the light-transmitting resin body is disposed inside the resin position limiting space and surrounded by the surrounding light-reflecting resin body.

3. The AC LED lamp structure of claim 1, wherein the light-emitting unit includes a first light-emitting group and a second light-emitting group, and the light-emitting module includes:
a frame unit including a first surrounding light-reflecting resin body surroundingly coated on the top surface of the circuit substrate and a second surrounding light-reflecting resin body surroundingly coated on the top surface of the circuit substrate for surrounding the first surrounding light-reflecting resin body, wherein the first surrounding light-reflecting resin body surrounds the first light-emitting group to form a first resin position limiting space on the circuit substrate, and the second surrounding light-reflecting resin body surrounds the second light-emitting group and the first surrounding light-reflecting resin body to form a second resin position limiting space on the circuit substrate and between the first surrounding light-reflecting resin body and the second surrounding light-reflecting resin body, the first surrounding light-reflecting resin body has a first convex junction portion formed on a top surface thereof, and the second surrounding light-reflecting resin body has a second convex junction portion formed on a top surface thereof; and
a package unit including a first light-transmitting resin body and a second light-transmitting resin body disposed on the top surface of the circuit substrate to respectively enclose the first light-emitting group and the second light-emitting group, wherein the first light-transmitting resin body and the second light-transmitting resin body are respectively disposed inside the first resin position limiting space and the second resin position limiting space and respectively surrounded by the first surrounding light-reflecting resin body and the second surrounding light-reflecting resin body;
wherein the first light-emitting group includes a plurality of first LED chips disposed on the circuit substrate and electrically connected to the circuit substrate, the second light-emitting group includes a plurality of second LED chips disposed on the circuit substrate and electrically connected to the circuit substrate, wherein the first surrounding light-reflecting resin body and the second surrounding light-reflecting resin body are arranged in a pattern of concentric circles, the second light-emitting group is disposed between the first surrounding light-reflecting resin body and the second surrounding light-reflecting resin body, and the second light-emitting group surrounds the first surrounding light-reflecting resin body.

4. The AC LED lamp structure of claim 1, wherein each connection component includes a retaining element and a securing element connected between the retaining element and the carrier body, the retaining element has a positioning portion and a holding portion connected to the positioning portion, the positioning portion has a positioning hole, and the holding portion has a retaining space and a retaining rib disposed in the retaining space, wherein the securing element passes through the positioning hole to position the retaining element on the carrier body, and an outer perimeter portion of the transparent element is retained inside the retaining space and downwardly abutted against the retaining rib.

5. An AC LED lamp structure, comprising:
a light-emitting module including a circuit substrate positioned on a carrier body and a light-emitting unit disposed on the circuit substrate and electrically connected to the circuit substrate; and
a protection module including a transparent element disposed under the light-emitting unit and separated from the light-emitting unit and a plurality of connection components connected between the transparent element and the circuit substrate for positioning the transparent element under the circuit substrate by a predetermined distance.

6. The AC LED lamp structure of claim 5, wherein the light-emitting module includes:
a frame unit including a surrounding light-reflecting resin body surroundingly coated on the top surface of the circuit substrate, wherein the surrounding light-reflecting resin body surrounds the light-emitting unit to form a resin position limiting space on the circuit substrate, and the surrounding light-reflecting resin body has a convex junction portion formed on a top surface thereof; and
a package unit including a light-transmitting resin body disposed on the top surface of the circuit substrate for enclosing the light-emitting unit, wherein the light-transmitting resin body is disposed inside the resin position limiting space and surrounded by the surrounding light-reflecting resin body.

7. The AC LED lamp structure of claim 5, wherein the light-emitting unit includes a first light-emitting group and a second light-emitting group, and the light-emitting module includes:
a frame unit including a first surrounding light-reflecting resin body surroundingly coated on the top surface of the circuit substrate and a second surrounding light-reflecting resin body surroundingly coated on the top surface of the circuit substrate for surrounding the first surrounding light-reflecting resin body, wherein the first surrounding light-reflecting resin body surrounds the first light-emitting group to form a first resin position limiting space on the circuit substrate, and the second surrounding light-reflecting resin body surrounds the second light-emitting group and the first surrounding light-reflecting resin body to form a second resin position limiting space on the circuit substrate and between the first surrounding light-reflecting resin body and the second surrounding light-reflecting resin body, the first surrounding light-reflecting resin body has a first convex junction portion formed on a top surface thereof, and the second surrounding light-reflecting resin body has a second convex junction portion formed on a top surface thereof; and
a package unit including a first light-transmitting resin body and a second light-transmitting resin body disposed on the top surface of the circuit substrate to respectively enclose the first light-emitting group and the second light-emitting group, wherein the first light-transmitting resin body and the second light-transmitting resin body are respectively disposed inside the first resin position limiting space and the second resin position limiting space and respectively surrounded by the first surrounding light-reflecting resin body and the second surrounding light-reflecting resin body.

8. The AC LED lamp structure of claim 7, wherein the first light-emitting group includes a plurality of first LED chips disposed on the circuit substrate and electrically connected to the circuit substrate, the second light-emitting group includes a plurality of second LED chips disposed on the circuit substrate and electrically connected to the circuit substrate, wherein the first surrounding light-reflecting resin body and the second surrounding light-reflecting resin body are arranged in a pattern of concentric circles, the second light-emitting group is disposed between the first surrounding light-reflecting resin body and the second surrounding light-reflecting resin body, and the second light-emitting group surrounds the first surrounding light-reflecting resin body.

9. An AC LED lamp structure, comprising:
a light-emitting module including a circuit substrate positioned on a carrier body and a light-emitting unit disposed on the circuit substrate and electrically connected to the circuit substrate; and
a protection module including a protection casing for carrying the light-emitting module, a transparent element disposed inside the protection casing and separated from the light-emitting unit, and a plurality of connection components connected between the protection casing and the carrier body for positioning the transparent element under the circuit substrate by a predetermined distance.

10. The AC LED lamp structure of claim 9, wherein the protection casing includes a first casing body and a second casing body, the transparent element is enclosed and clamped between the first casing body and the second casing body, and the first casing body and the second casing body are connected with each other to form a single protection casing body, wherein the first casing body has a plurality of retaining portions contacting the circuit substrate for retaining the light-emitting module on a bottom side of the first casing body, wherein the first casing body has a first opening, the second casing body has a second opening, and a first aperture of the first opening of the first casing body is larger than a second aperture of the second opening of the second casing body.
